(19) United States
(12) Patent Application Publication
(10) Pub. No.: US 2006/0139154 A1
(43) Pub. Date: Jun. 29, 2006

(54) Remote access system for a vehicle

(76) Inventor: Jounghoon Kim, Los Angeles, CA (US)

Correspondence Address: PARK LAW FIRM, 3255 WILSHIRE BLVD, SUITE 1110, LOS ANGELES, CA, 90010, US

(21) Appl. No.: 11/012,934

(22) Filed: Dec. 14, 2004

(51) Int. Cl. B60R 25/10; H04N 7/18; G08B 1/08

(52) U.S. Cl. 340/426.18; 348/148; 340/539.1

(57) ABSTRACT

A remote access system for vehicle includes an image capturing device, a monitoring device, a data communicating device electronically connecting the image capturing device and the monitoring device, and a control module which detects the predetermined movements, triggers the image capturing device when detected, and activates the monitoring device. The image capturing device includes one or more video cameras installed in one or more locations inside the vehicle. The monitoring device includes a display, a manual activation switch, and an information processing device. The control box activates the image capturing device and sends the image to the monitoring device. The display includes an LCD device; color or monochrome. The monitoring device communicates with the data communicating device through RF devices. The control module processes the signals from the vehicle alarm device including the information on the status of doors, shock to the vehicle, trunk, and hood.

### BACKGROUND OF THE INVENTION

This invention is related to a remote access system for vehicle. More specifically, the invention is related to a remote access system for vehicle, which displays images of inside of vehicle upon occurrence of suspect security breach. The invention is also related to a remote access system for vehicle, which shows an owner of the vehicle the images of inside of the vehicle remotely upon the owner's request.

The highly industrialized society has made the automobile indispensable in everyday lives of modern people. People go working, shopping, and even just enjoying driving in all kinds of cars. In a large and crowded office town, we can imagine a situation of almost one to one correspondence between the people and the cars parked somewhere in the same or neighboring block. All the problems such as accommodation of parking spaces, security of the cars parked in a remote places, and the like became the major urban problems. Especially, the security of the automobiles is an immediate and direct concern of the drivers or owners of the automobiles. A man sitting in an office in a skyscraper is worrying about his nice and expensive car parked deep in the underground parking lot all day long. The situation is not better with a country farmer in a rural area that has many nooks and corners everywhere. People cannot live without automobiles, and naturally the people feel irritable away from their automobiles. They want to know and check the security of the cars as frequently as possible.

There are a couple of prior arts about the remote access system for vehicles including remote key entry systems. Some of the prior arts even provide the means to check the status of the vehicle. But, the status the prior arts provide is limited without exception, far from pacifying the owner's fretfulness about the car.

Accordingly, a need for a better art to provide a more comprehensive status information of vehicle to the owner exists for a long time. This invention is directed to solve these problems and satisfy the long-felt need.

### SUMMARY OF THE INVENTION

A remote access system for a vehicle is an innovation mainly on a security system for a vehicle. The present invention contrives to solve the disadvantages of the prior art.

An object of the invention is to provide a remote access system for a vehicle, which responds to a predetermined security situation of the vehicle with visual information.

Another object of the invention is to provide a remote access system for a vehicle, which can be activated to display an image of the vehicle remotely on a monitoring device.

Still other object of the invention is to provide a remote access system for a vehicle, which can display the image of inside of the vehicle in a snapshot or a stream of continuous images.

A remote access system for vehicle includes an image capturing device for capturing an image inside the vehicle, a monitoring device for receiving the captured image by the image capturing device remotely from the vehicle, a data communicating device electronically connecting the image capturing device and the monitoring device, and a control module which detects a predetermined event including movement of the vehicle and pressing of the manual activation switch, triggers the image capturing device when the predetermined event is detected, and activates the monitoring device. The monitoring device displays the captured image.

The image capturing device includes one or more video cameras, which are installed in one or more locations at the vehicle.

The monitoring device includes a display, an information processing device, and a manual activation switch. The manual activation switch sends a predetermined signal to the control module to activate the image capturing device. The control module activates the image capturing device and sends the image data to the monitoring device through the data communicating device. The display includes an LCD device; color or monochrome. The information processing device of the monitoring device includes a central processing unit, a signal decoding unit, and an image decoding unit. The data communicating device includes a RF device, an antenna, and a transmitter. The monitoring device does not include a separate memory, reducing the weight of the monitoring device.

The control module includes an information processing unit processing the signals from the vehicle alarm device and an image processing unit. The signals from the vehicle alarm device include the information on the opening/closing status of opening part such as doors, trunk, and hood, and shock to the vehicle. The information processing unit and the image processing unit of the control module perform a selection of images from the image capturing devices and queuing of the images.

The control module includes a information storing device. The information storing device stores an information including an image data, information on the image capturing device, and the status of the vehicle alarm device. The information processing unit of the control module retrieves and manipulates the information stored in the information storing device in order to display the images in a sequence with the edited orders and durations.

The information device of the monitoring device receives a serial signal from the RF device of the data communicating device, and sends the serial signal to the display of the monitoring device directly.

Many other innovations, features, and advantages will be evident with the following description of the invention.

### BRIEF DESCRIPTION OF THE DRAWINGS

These and other features, aspects and advantages of the present invention will become better understood with reference to the accompanying drawings, wherein:

FIG. 1 is a perspective view of a vehicle installed with a remote access system of the invention;

FIG. 2 is a perspective view of a monitoring device;

FIG. 3 is a schematic block diagram of a control module; and

FIG. 4 is a schematic block diagram of a monitoring device.

### DETAILED DESCRIPTION OF THE INVENTION

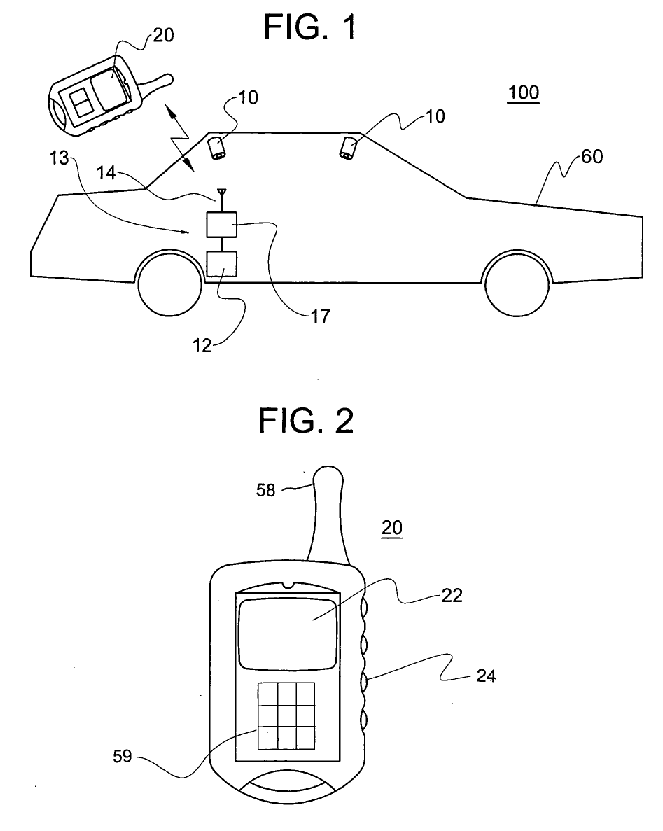

As shown in FIG. 1 and FIG. 2, a remote access system 100 for vehicle includes an image capturing device 10 for capturing an image inside a vehicle 60, a monitoring device 20 for receiving the captured image by the image capturing device 10 remotely from the vehicle 60, a data communicating device 13 electronically connecting the image capturing device 10 and the monitoring device 20, and a control module 12 which detects a predetermined movement of the vehicle 60, triggers the image capturing device 10 when the predetermined movement is detected, and activates the monitoring device 20. The monitoring device 20 displays the captured image. Since the monitoring device 20 does not includes a separate memory, the monitoring device 20 can be manufactured lightly in weight.

The image capturing device 10 includes one or more video cameras, which are installed in one or more locations inside the vehicle 60 with different views and angles.

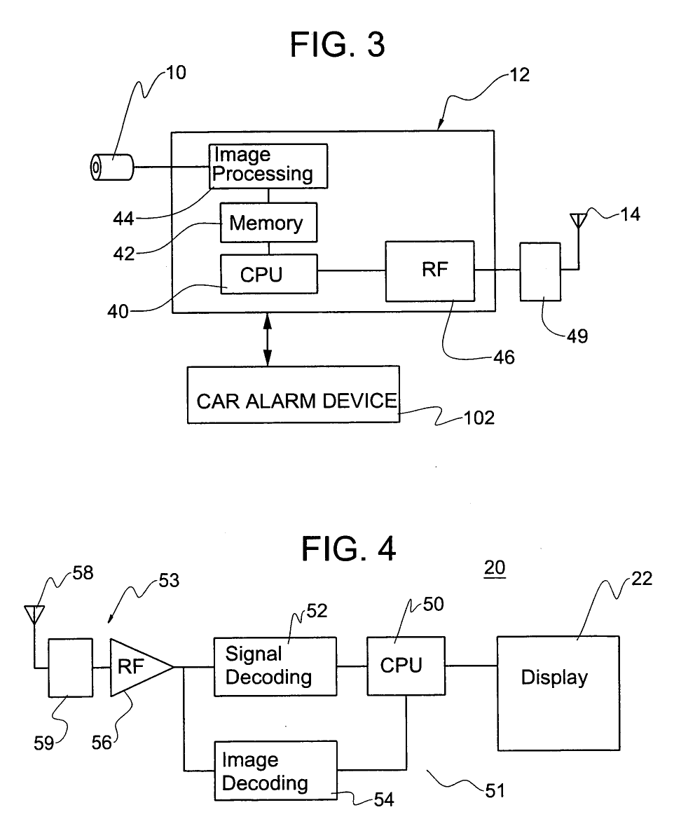

FIG. 3 and FIG. 4 show schematic diagrams of the control module 12 and the monitoring device 20.

The monitoring device 20 includes a display 22, an information processing unit 50, and a manual activation switch 24. If the manual activation switch 24 is pressed, the monitoring device 20 sends a predetermined signal to the control module 12 to activate the image capturing device 10 even when there is no situation of security breach. By that, an owner of the vehicle 60 can check the status of her or his car any time he wants.

Once prompted by the security breach situation or the manual activation switch 24, the control module 12 activates the image capturing device 10 and sends the image data to the monitoring device 20 through the data communicating device 13. The display 22 includes an LCD device; color or monochrome. The images or video data can be displayed on the display 22 of the monitoring device 20, preferably a remote detached from the rest of the system 100 in snapshots or stream of the images or video data.

The information processing device 51 of the monitoring device 20 includes a central processing unit 50, a signal decoding unit 52, and an image decoding unit 54. The data communicating device 53 of the monitoring device 20 includes a RF device 56, an antenna 58 and a transmitter 59.

The control module 12 includes an information processing unit 40 processing the signals from the vehicle alarm device 102 and an image processing unit 44. The signals from the vehicle alarm device 102 include the information on the opening/closing status of opening parts of the vehicle 100 such as doors, trunk, and hood of the vehicle 100, and shock to the vehicle 100. The information processing unit 40 and the image processing unit 44 of the control module 12 perform a selection of images from the image capturing devices 10 and queuing of the images in order to show the views from a plurality of different cameras 10 in predetermined order. The monitoring device 20 can further include a data input panel 23 for generating a combination of commands for the control module 12. The commands are about selective activation of the cameras 10, change of queuing order of images, etc.

The control module 12 includes an information storing device 42. The information storing device 42 stores an information including an image data, information on the image capturing device 10, and the status of the vehicle alarm device 102. The information processing unit 40 of the control module 12 retrieves and manipulates the information stored in the information storing device 44 in order to display the images in a sequence with the edited orders and durations.

A video information about the inside of the vehicle 60 captured by the image capturing device 10, which is sent out electro-magnetically via the data communicating device 13 upon triggering caused by predetermined situations of the vehicle 60.

Once the signals from the vehicle alarm device 102 is received, the control module 12 makes the image capturing device 10 capture the images with a predetermined view and angle of the inside of the vehicle 60 and transmitted through the data communicating device 13.

Also, the control module 12 activates the image capturing device 10 and the monitoring device 20 upon triggering the manual activation switch 24 on the monitoring device 20.

The monitoring device 20 displays one or more images with a predetermined view and angle of the inside of the vehicle 60, which are captured by the image capturing device 10 and transmitted through the data communicating device 13. The image processing unit 54 of the monitoring device 20 processes the data from the image capturing device 10.

The image captured by the image capturing device 10 can be sent to and displayed on the monitoring device 20 either directly or indirectly through the memory 42 with some delay due to processing by the information processing unit 50.

The information device 54 of the monitoring device 20 receives a serial signal from the RF device 46 of the data communicating device 12, and sends the serial signal to the display 22 of the monitoring device 20 directly.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A remote access system for a vehicle comprising:
a) an image capturing device for capturing an image, wherein the image capturing device is installed in one or more locations at the vehicle;
b) a monitoring device for receiving the captured image by the image capturing device remotely from the vehicle;
c) a data communicating device electronically connecting the image capturing device and the monitoring device; and
d) a control module which detects a predetermined event in the vehicle, triggers the image capturing device when the predetermined event is detected, and activates the monitoring device,
wherein the monitoring device displays the captured image.

2. The remote access system of claim 1, wherein the image capturing device comprises one or more video camera.

3. The remote access system of claim 1, wherein the monitoring device comprises a display, and an information processing device.

4. The remote access system of claim 3, wherein the monitoring device further comprises a manual activation switch, wherein the predetermined event comprises a pressing of the manual activation switch of the monitoring device.

5. The remote access system of claim 4, wherein the manual activation switch sends a predetermined signal to the control module to activate the image capturing device, wherein the control module activates the image capturing device and sends the image data to the monitoring device through the data communicating device.

6. The remote access system of claim 1, wherein the predetermined event in the vehicle comprises a predetermined movement of the vehicle.

7. The remote access system of claim 3, wherein the display comprises an LCD device.

8. The remote access system of claim 7, wherein the LCD device is a monochrome or color display.

9. The remote access system of claim 8, wherein the information device of the monitoring device receives a serial signal from the RF device of the data communicating device, sent the serial signal to the display of the monitoring device directly.

10. The remote access system of claim 3, wherein the information processing device comprises a central processing unit, a signal decoding unit, and an image decoding unit.

11. The remote access system of claim 3, wherein the data communicating device comprises an RF device, an antenna, and a transmitter.

12. The remote access system of claim 1, wherein the control module comprises an information processing unit processing the signals from the vehicle alarm device and an image processing unit.

13. The remote access system of claim 12, wherein the signals from the vehicle alarm device comprise the information on the opening/closing status of the opening part of the vehicle.

14. The remote access system of claim 12, wherein the signals from the vehicle alarm device comprise the information on a shock to the vehicle.

15. The remote access system of claim 14, wherein the information processing unit and the image processing unit perform a selection of images from the image capturing devices and queuing of the images.

16. The remote access system of claim 1, wherein the control module comprises a information storing device.

17. The remote access system of claim 16, wherein the information storing device stores an information comprising an image data, information on the image capturing device, and the status of the vehicle alarm device.

18. The remote access system of claim 17, wherein the information processing unit retrieves and manipulates the information stored in the information storing device in order to display the images in a sequence with the edited orders and durations.

19. The remote access system of claim 1, wherein the monitoring device is a remote physically separated from the vehicle.

20. The remote access system of claim 1, wherein the information device of the monitoring device receives a serial signal from the RF device of the data communicating device, and sends the serial signal to the display of the monitoring device directly.
